(19) United States
(12) Patent Application Publication
(10) Pub. No.: US 2007/0250605 A1
(43) Pub. Date: Oct. 25, 2007

(54) Automatic discovery and configuration of network devices

(75) Inventors: Douglas P. Duchene, Sammamish, WA (US); Gursharan S. Sidhu, Seattle, WA (US); Kuansan Wang, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/409,947

(22) Filed: Apr. 24, 2006

(51) Int. Cl. G06F 15/177; G06F 15/173

(52) U.S. Cl. 709/220; 709/223

(57) ABSTRACT

Various technologies and techniques are disclosed for automatically configuring devices on a network. The network adapters on a device are enumerated with a DHCP DISCOVER request. The system determines that the DHCP DISCOVER request will not return a complete set of information needed to configure the device, and broadcasts a DHCP INFORM request over a network to obtain additional information. The DHCP INFORM request includes a parameter requesting one or more server addresses, and at least one identification parameter that describes the device. The device listens for at least one response on its network adapters. Upon receiving at least one response to the DHCP INFORM request, the device takes an appropriate configuration action based on the response.

### BACKGROUND

Today, advanced telephone systems (key systems, PBXs, etc.) require substantial advanced knowledge for setup, configuration, and maintenance. If a small business, home-based business, or high-end home wants to purchase an advanced phone system, the customer must hire an outside firm to perform the majority of the installation work. Furthermore, when changes are required, the outside firm must be hired again to make the change. Sometimes the changes are as small as adjusting the time twice a year for daylight savings.

Voice Over IP (VoIP) is a technology that is gradually making advanced phone systems easier to use and bringing them closer to being something that can be installed by a home owner or small business owner with basic knowledge of computer networking. However, most VoIP phone systems today still require advanced networking knowledge for setup, configuration, and maintenance. VoIP phones are not yet “plug and play” with regard to setup.

There are existing methods that could make VoIP phones “plug and play”, but these methods have several problems. First, the methods typically require the use of static IP address, or a level of control over the dynamic host configuration protocol (DHCP) server(s) on the network that requires skills and resources not readily available to small businesses or home users. Second, the methods require a domain name server (DNS) that covers the scope of the home or small business network. The typical home and small business today does not have a DNS that covers the scope of devices inside the local area network.

The problem of automatic device configuration is not just limited to VoIP telephones, either. These same problems discussed with respect to VoIP telephones also apply to other devices, such as printers, and various other devices that can be shared over a network.

### SUMMARY

Various technologies and techniques are disclosed for automatically configuring devices on a network. The network adapters on a device are enumerated with a DHCP DISCOVER request. If the system determines that the DHCP DISCOVER request did not return a complete set of information needed to configure the device, the system broadcasts a DHCP INFORM request over a network to obtain additional information. The DHCP INFORM request includes a parameter requesting a server address, and at least one identification parameter that describes the device. The device listens for at least one response on its network adapters. Upon receiving at least one response to the DHCP INFORM request, the device takes an appropriate configuration action based on the response, such as registering the device with a particular server.

In one implementation, one or more of these technologies and techniques are used to automatically configure voice over IP telephones. In other implementations, other network devices are automatically configured. Yet in another implementation, one or more of these technologies and techniques are used to perform error recovery for a device that has stopped functioning.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a device discovery and configuration application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in automatically configuring and/or reconfiguring a device.

FIG. 5 is a process flow diagram for one implementation of the system of FIG. 1 illustrating the stages involved in a server or other device participating in the automatic device configuration process.

FIG. 6 is a process flow diagram for one implementation of the system of FIG. 1 illustrating the stages involved in configuring a device using an administration console.

FIG. 7 is a process flow diagram for one implementation of the system of FIG. 1 that illustrates automatically connecting to the device to configure it.

FIG. 8 is a process flow diagram for one implementation of the system of FIG. 1 that illustrates re-registering a device when registration failed.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that automatically configures devices on a network, but the system also serves other purposes in addition to these. In one implementation, one or more of the techniques described herein can be implemented as features within any other type of program or service that takes part in a device configuration process, such as the device itself and/or a server or other device that the device needs to be configured to interface with.

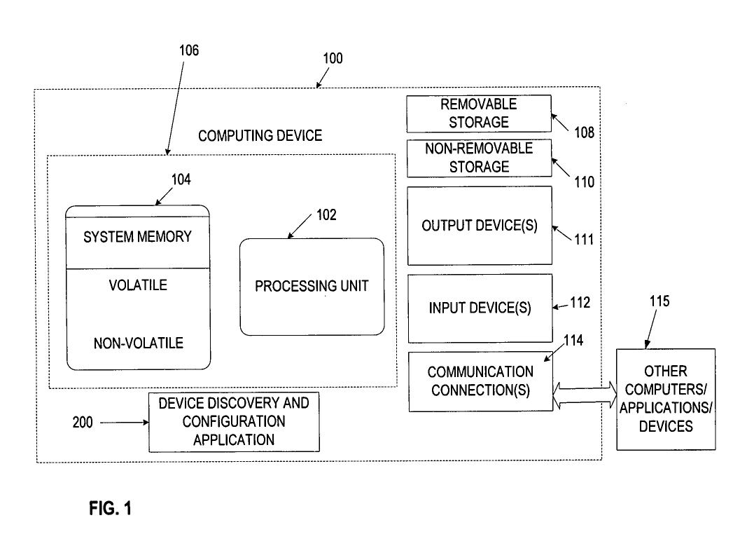

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

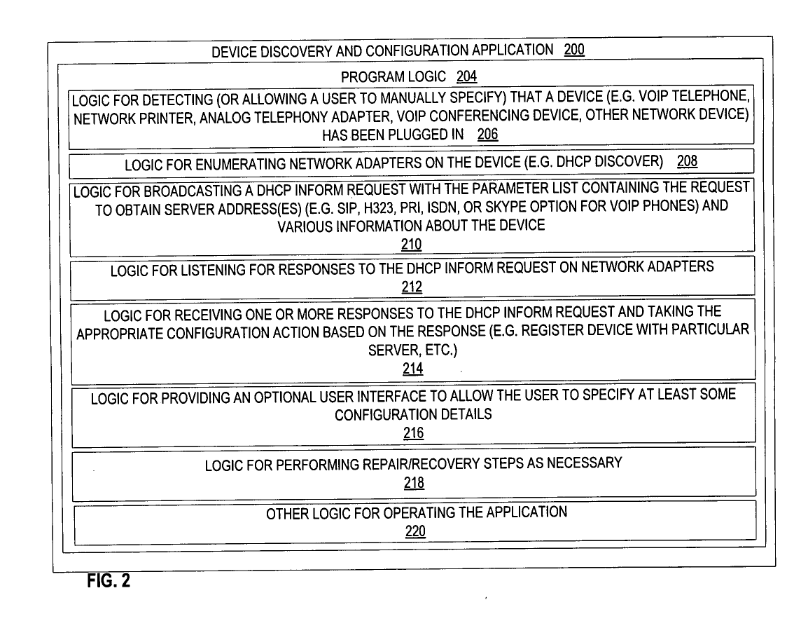

Computing device 100 includes one or more communication connections 114 that allow computing device 100 to communicate with other computers, applications, and/or devices 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 can be a voice over IP telephone, a network printer, or another shared device on a network. In one implementation, computing device 100 includes device discovery and configuration application 200. Device discovery and configuration application 200 will be described in further detail in FIG. 2.

Turning now to FIG. 2 with continued reference to FIG. 1, a device discovery and configuration application 200 operating on computing device 100 is illustrated. Device discovery and configuration application 200 is one of the application programs that reside on computing device 100. However, it will be understood that device discovery and configuration application 200 can alternatively or additionally be embodied as computer-executable instructions on one or more computers and/or in different variations than shown on FIG. 1. Alternatively or additionally, one or more parts of device discovery and configuration application 200 can be part of system memory 104, on other computers, applications, and/or devices 115, or other such variations as would occur to one in the computer software art.

Device discovery and configuration application 200 includes program logic 204, which is responsible for carrying out some or all of the techniques described herein. Program logic 204 includes logic for detecting (or allowing a user to manually specify) that a device (such as a VoIP phone, printer, analog telephony adapter, VoIP conferencing device [e.g. device that mixes multiple media streams for a conference], or other network device) has been plugged in 206; logic for enumerating network adapters on the device (e.g. with DHCP DISCOVER request) 208; logic for broadcasting a DHCP INFORM request with the parameter list containing the request to obtain server address(es) (e.g. SIP, H.323, PRI, ISDN, or Skype option for VoIP phones) and various information about the device 210; logic for listening for responses to the DHCP INFORM request on network adapters 212; logic for receiving one or more responses to the DHCP INFORM request and taking the appropriate configuration action based on the response (e.g. register device with particular server, etc.) 214; logic for providing an optional user interface to allow the user to specify at least some configuration details 216; logic for performing repair/recovery steps as necessary 218; and other logic for operating application 220. In one implementation, program logic 204 is operable to be called programmatically from another program, such as using a single call to a procedure in program logic 204.

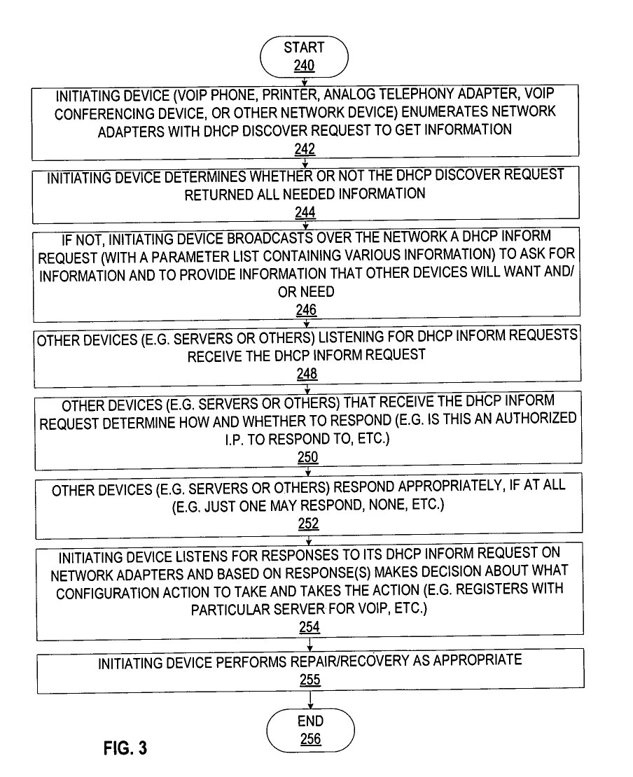

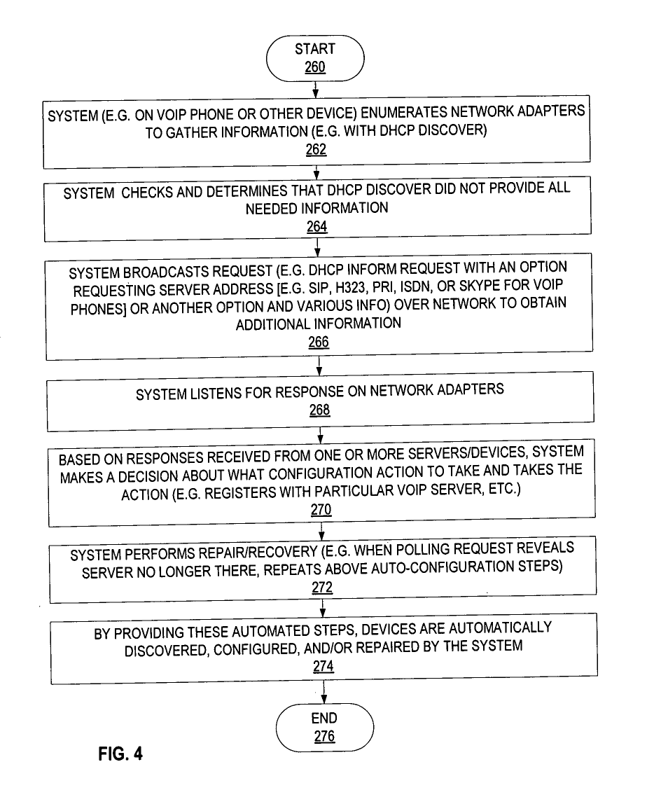

Turning now to FIGS. 3-4 with continued reference to FIGS. 1-2, the stages for implementing one or more implementations of device discovery and configuration application 200 are described in further detail. FIG. 3 is a high level process flow diagram for one implementation of device discovery and configuration application 200. In one form, the process of FIG. 3 is at least partially implemented in the operating logic of computing device 100.

The procedure begins at start point 240 with the initiating device (e.g. a VoIP telephone, printer, analog telephony adapter, VoIP conferencing device [e.g. device that mixes multiple media streams for a conference], or other network device) enumerating its network adapters with a DHCP DISCOVER request to get information (stage 242). The initiating device determines whether the responses to its DHCP DISCOVER request contain all the needed information (stage 244). If not, the initiating device broadcasts over each such network a DHCP INFORM request (with a parameter list containing various information) to ask for information and to provide information that other devices will want and/or need (stage 246). Other devices (e.g. servers or other devices) listening for DHCP INFORM requests receive the DHCP INFORM request (stage 248). Other devices (e.g. servers or other devices) that receive the DHCP INFORM request determine how and whether to respond (e.g. is this DHCP FNFORM arriving from an authorized IP address to respond to, etc.) (stage 250). Other devices (e.g. servers or other devices) respond appropriately, if at all (stage 252). In one implementation, only one server or other device may respond to the request. In another implementation, no servers or other devices may responds to the request. In yet another implementation, more than one server or other device may respond.

The initiating device listens for responses to its DHCP INFORM requests on its network adapters and based on response(s) received, makes a decision about what configuration action to take and takes that action (stage 254). As one non-limiting example, if the device is a VoIP telephone, the action could be registering with a particular telephony server. For the sake of clarity, some of the stages involved in the DHCP INFORM request and response process for one implementation have been omitted. In such an implementation, the device sends out a DHCP DISCOVER, to which one or more servers on the network can respond with a DHCP OFFER. Multiple offers can be received as a result. The device then picks one of the offers and sends a DHCP REQUEST. The specific server then responds with an ACK to close the handshake. It is in the last step, ACK, that the device receives its IP addresses, net masks, and other needed information.

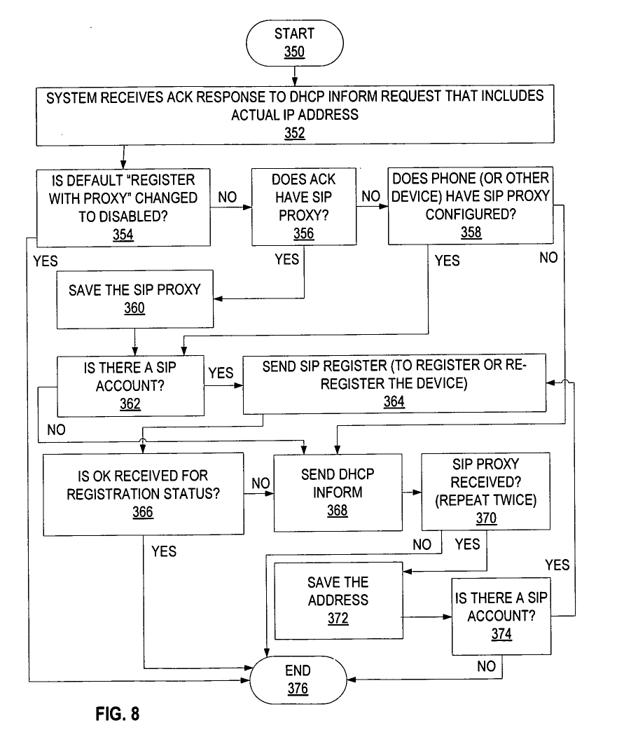

The initiating device performs repair/recovery as appropriate (stage 255). As one non-limiting example, the auto-configuration stages can be repeated when a device, such as a VoIP telephonie, detects that the server it is registered with cannot be located. In one implementation, the process of FIG. 8 is performed as appropriate to perform this repair/recovery. The process ends at end point 256.

FIG. 4 illustrates one implementation of a more detailed process for automatically configuring and/or reconfiguring a device. In one form, the process of FIG. 4 is at least partially implemented in the operating logic of computing device 100. The procedure begins at start point 260 with the system (e.g. on VoIP phone or other device) enumerating its network adapters to gather information (e.g. with DHCP DISCOVER request) (stage 262). The system checks and determines that DHCP DISCOVER did not provide all of the needed information (stage 264). In another implementation, if sufficient information has been offered in the responses, the system moves on to execute configuration action (stage 270). On the other hand, if more information is needed because the DHCP DISCOVER did not provide all the needed information (stage 264), the system broadcasts a request (e.g. a DHCP INFORM request with an option requesting server address [e.g. SIP, H.323, PRI, ISDN, or Skype option for VoIP phones] or another option and various info) over the network to obtain additional information (stage 266). The system listens for a response on the network adapters (stage 268). Based on responses received from one or more servers/devices, the system makes a decision about what configuration action to take and takes the action (e.g. registers with a particular VoIP server, etc.) (stage 270). The system performs repair/recovery and repeats the auto-configuration steps as needed. One non-limiting example of when the system performs repair/recovery includes when a polling or other request made by the device reveals that the server is no longer there or is failing to respond (stage 272). By providing these automated steps, devices are automatically discovered, configured, and/or repaired by the system (stage 274). The process ends at end point 276.

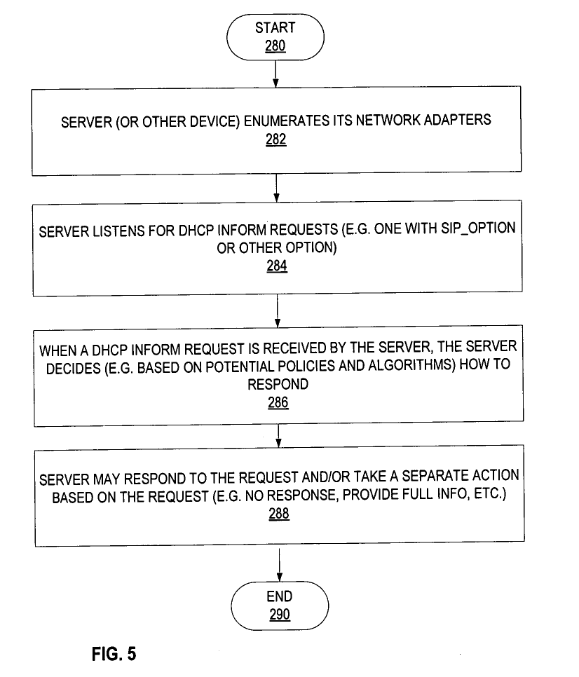

FIG. 5 illustrates the stages involved in a server or other device participating in the automatic device configuration process in one implementation. In one form, the process of FIG. 5 is at least partially implemented in the operating logic of a computing device having a similar configuration as computing device 100. The procedure begins at start point 280 with the server (or other device) enumerating its network adapters (stage 282). The server listens for DHCP INFORM requests (e.g. one with the SIP_OPTION or other option) (stage 284). When a DHCP INFORM request is received by the server, the server decides (e.g. based on potential policies and algorithms) how to respond (stage 286). Below are a few non-limiting examples of potential policies that could be used by the server(s) to decide how to respond:
The server may be of brand X and may be programmed only to respond to requests from devices of the same brand X and of a compatible version of operating logic/software.
The device may be of brand X and may be programmed only to respond to requests from servers of the same brand X and of a compatible version of operating logic/software.
Two servers may be on the same LAN. Server A may be configured as the primary server and Server B may be configured as the backup server. Server B may only respond if Server A does not respond within a certain amount of time, such as five seconds.
Based on administrative requirements, the server may only respond to a device if the device is on the list of approved devices. The list of approved devices could be in the form of a list of media access control (MAC) addresses or some other device identifiers.

After evaluating the request against the applicable policy and/or policies, the server may respond to the request and/or take a separate action based on the request (e.g. provide no response, provide full information, etc.) (stage 288). The process ends at end point 290.

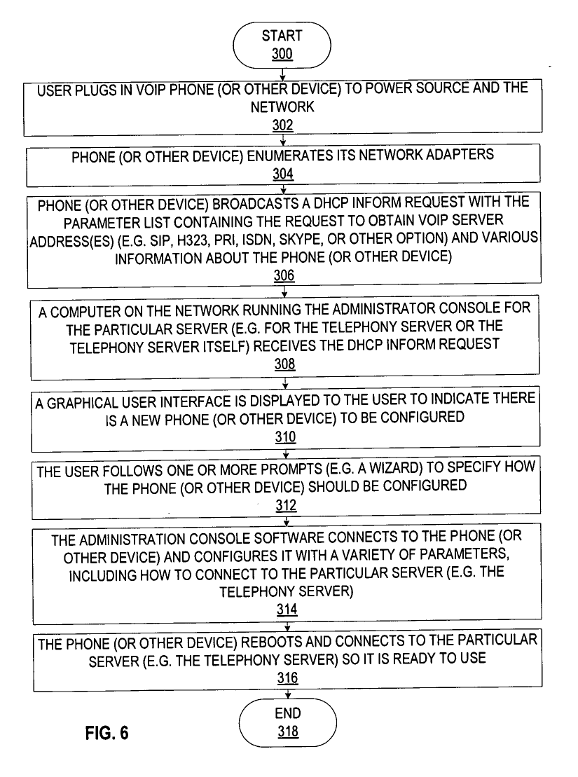

FIG. 6 illustrates the process for configuring a device using an administration console in one implementation involving VoIP phones in more detail. The configuration process using an administration console can be used instead of or in addition to the automatic discovery and configuration stages described in some of the other figures. Those skilled in the art will appreciate that this particular example can be extended to numerous networked applications other than VoIP phones described herein. In one form, the process of FIG. 6 is at least partially implemented in the operating logic of computing device 100 or on other devices having a similar configuration to computing device 100. The procedure begins at start point 300 with the user plugging in a VoIP phone (or other device) to a power source and the network (stage 302). The VoIP phone (or other device) enumerates all or some of its network adapters (stage 304). The VoIP phone (or other device) broadcasts a DHCP INFORM request with the parameter list containing the request to obtain VoIP server address(es) (e.g. SIP, H.323, PRI, ISDN, or Skype option) and containing various information about the phone (or other device) (stage 306). A device on the network running the administrator console for the particular server (e.g. for the telephony server or the telephony server itself) receives the DHCP INFORM request (stage 308).

A graphical user interface is displayed to the user to indicate there is a new phone (or other device) to be configured (stage 310). In one implementation, the graphical user interface is displayed on the display of the new phone (or other device) itself In another implementation, the new phone (or other device) runs a mini Web server that contains logic to serve up web pages so that the user can interact with the device using any Web browser on a PC connected to the same network. In other implementations, the user interface can be located on other computers than the device itself and used to configure the device. The user follows one or more prompts (e.g. a wizard) to specify how the phone (or other device) should be configured (stage 312). The administration console software connects to the phone (or other device) and configures it with a variety of parameters, including how to connect to the particular server (e.g. the telephony server) so it is ready to use (stage 314). The phone (or other device) reboots and connects to the particular server (e.g. telephony server) so it is ready to use (stage 316). The process ends at end point 318.

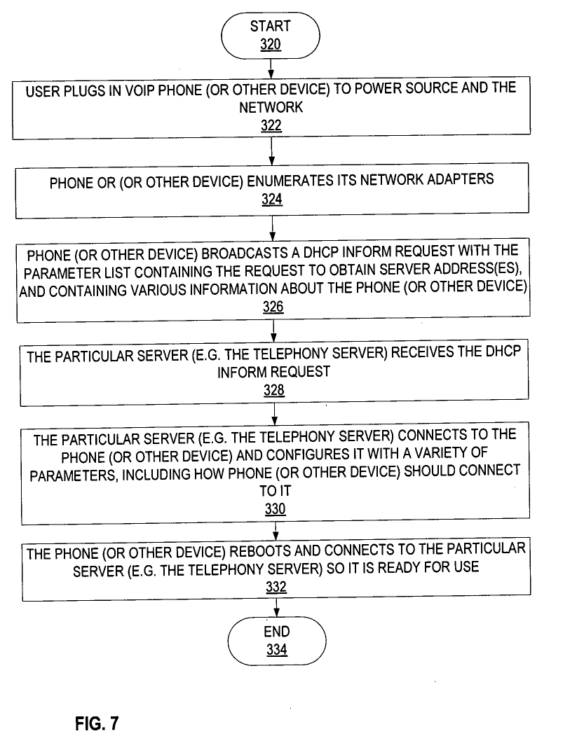

FIG. 7 is a process flow diagram for one implementation that illustrates automatically connecting to the device to configure it. In one form, the process of FIG. 7 is at least partially implemented in the operating logic of computing device 100. The procedure begins at start point 320 with the user plugging in a VoIP phone (or other device) to a power source and the network (stage 322). The VoIP phone (or other device) enumerates all or some of its network adapters (stage 324). The VoIP phone (or other device) broadcasts a DHCP INFORM request with the parameter list containing the request for VoIP server address(es) and containing various information about the phone (stage 326). The particular server (e.g. the telephony server) receives the DHCP INFORM request (stage 328). The particular server (e.g. the telephony server) connects to the phone (or other device) and configures it with a variety of parameters, including how the phone (or other device) should connect to it (stage 330). The VoIP phone (or other device) reboots and connects to the particular server (e.g. the telephony server) so it is ready for use (stage 332). The process ends at end point 334.

FIG. 8 is a process flow diagram for one implementation that illustrates re-registering a device when registration failed. In one form, the process of FIG. 8 is at least partially implemented in the operating logic of computing device 100. The procedure begins at start point 350 with the system receiving an acknowledgement (ACK) response to the DHCP INFORM request, the response including the actual IP address of the server (stage 352). If the default “register with proxy” option is changed to disabled (decision point 354), then the process ends at end point 376. If not (decision point 354), the system checks to see if the ACK has a SIP proxy (decision point 356). If the ACK does have a SIP proxy (decision point 356), then the system saves the SIP proxy (stage 360) and initiates the SIP registration stages described below in stage 362. If the ACK does not have a SIP proxy, then the system checks to see if the phone or other device has a SIP proxy configured (decision point 358). If the phone or other device does not have a SIP proxy configured (decision point 358), then the system initiates the DHCP INFORM stages described below in stage 368.

If the ACK has a SIP proxy (decision point 356) or if the phone or other device has the SIP proxy configured (decision point 358), then the system checks to see if there is a SIP account (decision point 362). If there is not a SIP account, then the system initiates the DHCP INFORM stages described below in stage 368. If there is a SIP account (decision point 362), then the system sends the SIP REGISTER command to register or re-register the device (stage 364). If an OK status is received for the registration status in response to the SIP REGISTER command (decision point 366), then the process ends at end point 376. If an OK status is not received in response to the SIP REGISTER command, then the system sends a DHCP INFORM command (stage 368). If a SIP proxy is received (decision point 370) in response to the DHCP INFORM request, then the system saves the address (stage 372).

If a SIP proxy is not received from the DHCP INFORM request, then the DHCP INFORM request is sent a second time. If the SIP proxy is not received (after trying the DHCP INFORM twice), then the process ends at end point 376. If the SIP proxy is received the second time, then the address is saved (stage 372). In either event that the SIP proxy is received and saved (stage 372), the system then checks to see if there is a SIP account (stage 374). If not, the process ends at end point 376. If there is a SIP account, the stages beginning at 364 repeat to register or re-register the device. If there is not a SIP account, then the process ends at end point 376.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for automatically configuring a device comprising the steps of:
enumerating at least one network adapter on a device with a DHCP DISCOVER request;
broadcasting a DHCP INFORM request over a network to obtain additional information;
listening for at least one response on the at least one network adapter;
receiving at least one response to the DHCP INFORM request; and
determining an action to take based on the response, wherein the action is related to configuring the device.

2. The method of claim 1, wherein the DHCP INFORM request includes a parameter requesting a server address.

3. The method of claim 1, wherein the DHCP INFORM request includes at least one piece of information describing the device.

4. The method of claim 1, wherein the device is a voice over IP telephone.

5. The method of claim 4, wherein the at least one response is received from a telephony server.

6. The method of claim 5, wherein the action includes registering the voice over IP telephone with the telephony server.

7. The method of claim I, wherein the enumerating, broadcasting, listening, receiving, and determining steps are used for performing error recovery for the device.

8. The method of claim 1, wherein the device is a network printer.

9. The method of claim 1, wherein the response is received from a computer on the network that connects to the device and provides at least one configuration parameter to the device.

10. The method of claim 9, wherein the device action includes rebooting the device and connecting to the computer using the at least one configuration parameter.

11. A computer-readable medium having computer-executable instructions for causing a computer to perform the steps recited in claim 1.

12. A computer-readable medium having computer-executable instructions for causing a computer to perform steps comprising:
enumerate at least one network adapter on a device with a DHCP DISCOVER request;
determine that the DHCP DISCOVER request did not return a complete set of information needed to configure the device;
broadcast a DHCP INFORM request over a network to obtain additional information, wherein the DHCP INFORM request includes a parameter requesting a server address and at least one identification parameter that describes the device;
listen for at least one response on the at least one network adapter;
receive at least one response to the DHCP INFORM request; and
take an appropriate configuration action based on the response.

13. The computer-readable medium of claim 12, wherein the configuration action includes registering the device with a particular server on the network.

14. The computer-readable medium of claim 12, wherein the response is received from a computer on the network that connects to the device and provides at least one configuration parameter to the device.

15. A method for automatically configuring a device comprising the steps of:
providing a computer that receives a DHCP INFORM request from a device over a network, wherein the DHCP INFORM request includes a parameter requesting a server address and at least one identification parameter that describes the device; and
connecting the computer to the device over the network and configuring the device with at least one configuration parameter that describes how the device should communicate with the computer.

16. The method of claim 15, wherein the computer is a telephony server.

17. The method of claim 15, wherein the device is a voice over IP telephone.

18. The method of claim 15, wherein the computer connects to the device over the network using an administration console.

19. The method of claim 15, wherein after the computer receives the DHCP INFORM request, a user interface is displayed to the user to indicate the device has been detected for configuration.

20. A computer-readable medium having computer-executable instructions for causing a computer to perform the steps recited in claim 15.
